(19) United States
(12) Patent Application Publication
(10) Pub. No.: US 2026/0205756 A1
(43) Pub. Date: Jul. 16, 2026

(54) IMPULSE RESPONSE DETERMINATION METHOD AND ELECTRONIC DEVICE FOR PERFORMING METHOD

(71) Applicant: Electronics and Telecommunications Research Institute, Daejeon (KR)

(72) Inventors: Dae Young JANG, Daejeon (KR); Jiahong ZHAO, Southampton (GB); Xiguang ZHENG, Beijing (CN); Christian RITZ, Tarrawanna (AU)

(73) Assignee: Electronics and Telecommunications Research Institute, Daejeon (KR)

(21) Appl. No.: 19/137,684

(22) PCT Filed: Oct. 27, 2023
(86) PCT No.: PCT/KR2023/016914

§ 371 Date: Jun. 11, 2025

(30) Foreign Application Priority Data
Dec. 20, 2022 (KR) 10-2022-0178948
May 23, 2023 (KR) 10-2023-0066313

(51) Int. Cl. H04S 7/00

(52) U.S. Cl. CPC H04S 7/303; H04S 7/305; H04S 2400/11

(57) ABSTRACT

A method of determining an impulse response and an electronic device performing the method are disclosed according to various embodiments. The method of determining the impulse response according to various embodiments includes, using a first impulse response at a first position and a second impulse response at a second position for a source, extracting a specular reflection component of the first impulse response and the second impulse response, determining a first direction of arrival (DOA) of the first impulse response and a second DOA of the second impulse response using the specular reflection component of the first impulse response and the second impulse response, estimating a position of the source based on the first DOA and the second DOA, and determining an impulse response at a position of a listener based on the position of the source.

### TECHNICAL FIELD

The following description relates to a method of determining an impulse response and an electronic device for performing the method.

### BACKGROUND ART

A directional room impulse response (DRIR) may be estimated at a new listening position in a virtual space audio environment by interpolating a DRIR known at a different position.

When a listener moves in a streaming virtual reality (VR) session, a room impulse response (RIR) transmission requirement to apply a space audio scene may be reduced by interpolating a DRIR at a known position and estimating the DRIR at a position of a listener.

The above description has been possessed or acquired by the inventor(s) in the course of conceiving the present disclosure and is not necessarily an art publicly known before the present application is filed.

### DISCLOSURE OF THE INVENTION

### Technical Goals

According to various embodiments, an impulse response at a position of a listener in a virtual space may be determined by interpolating a known impulse response.

However, the technical aspects are not limited to the aforementioned aspects, and other technical aspects may be present.

### Technical Solutions

A method of determining an impulse response according to various embodiments includes, using a first impulse response at a first position and a second impulse response at a second position for a source, extracting a specular reflection component of the first impulse response and the second impulse response, determining a first direction of arrival (DOA) of the first impulse response and a second DOA of the second impulse response using the specular reflection component of the first impulse response and the second impulse response, estimating a position of the source based on the first DOA and the second DOA, and determining an impulse response at a position of a listener based on the position of the source.

The determining of the impulse response at the position of the listener may include determining a third DOA at the position of the listener and a time of arrival (TOA) at the position of the listener based on the position of the source and calculating the impulse response at the position of the listener using the third DOA at the position of the listener and the TOA at the position of the listener.

The calculating of the impulse response at the position of the listener may include correcting at least one of the first impulse response and the second impulse response based on the third DOA and the TOA.

The method may further include calculating a diffuse component of at least one of the first impulse response and the second impulse response. The calculating of the impulse response at the position of the listener may include calculating the impulse response at the position of the listener based on the diffuse component and a set weight.

The estimating of the position of the source may include estimating the position of the source and a position of an image source corresponding to the source, using triangulation.

The extracting of the specular reflection component may include extracting the specular reflection component of the first impulse response and the second impulse response to be less than or equal to a set number, respectively.

The extracting of the specular reflection component may include detecting a peak based on power of a W channel of the first impulse response and the second impulse response and extracting the specular reflection component of the first impulse response and the second impulse response based on the peak.

The detecting of the peak may include applying a first filter and a second filter to the power of the W channel and detecting the peak based on a ratio of the power of the W channel to which the first filter is applied and the power of the W channel to which the second filter is applied.

A method of determining an impulse response according to various embodiments includes, using a first impulse response at a first position and a second impulse response at a second position for a source, extracting a specular reflection component of the first impulse response and the second impulse response, determining a first DOA of the first impulse response and a second DOA of the second impulse response using the specular reflection component of the first impulse response and the second impulse response, and when a position of a listener is on a straight line between the first position and the second position, determining an impulse response at the position of the listener based on the first DOA and the second DOA.

The determining of the impulse response at the position of the listener may include determining a third DOA at the position of the listener and a TOA at the position of the listener, using linear interpolation.

An electronic device according to various embodiments includes a processor, and the processor is configured to, using a first impulse response at a first position and a second impulse response at a second position for a source, extract a specular reflection component of the first impulse response and the second impulse response, determine a first DOA of the first impulse response and a second DOA of the second impulse response using the specular reflection component of the first impulse response and the second impulse response, estimate a position of the source based on the first DOA and the second DOA, and determine an impulse response at a position of a listener based on the position of the source.

The processor may be configured to determine a third DOA at the position of the listener and a TOA at the position of the listener based on the position of the source and calculate the impulse response at the position of the listener using the third DOA at the position of the listener and the TOA at the position of the listener.

The processor may be configured to correct at least one of the first impulse response and the second impulse response based on the third DOA and the TOA.

The processor may be configured to calculate a diffuse component of at least one of the first impulse response and the second impulse response and calculate the impulse response at the position of the listener based on the diffuse component and a set weight.

The processor may be configured to estimate the position of the source and a position of an image source corresponding to the source, using triangulation.

The processor may be configured to extract the specular reflection component of the first impulse response and the second impulse response to be less than or equal to a set number, respectively.

The processor may be configured to detect a peak based on power of a W channel of the first impulse response and the second impulse response and extract the specular reflection component of the first impulse response and the second impulse response based on the peak.

The processor may be configured to apply a first filter and a second filter to the power of the W channel and detect the peak based on a ratio of the power of the W channel to which the first filter is applied and the power of the W channel to which the second filter is applied.

An electronic device according to various embodiments includes a processor, and the processor is configured to receive a bitstream comprising a position of a listener, a position of a source, a first impulse response at a first position, and a second impulse response at a second position and determine a third impulse response at the position of the listener by interpolating the first impulse response and the second impulse response based on the position of the source and the position of the listener.

A specular reflection component of the first impulse response and the second impulse response may be extracted, and a first DOA of the first impulse response and a second DOA of the second impulse response may be determined using the specular reflection component of the first impulse response and the second impulse response, and the position of the source may be estimated based on the first DOA and the second DOA.

### Effects

According to various embodiments, an impulse response at a new listening position may be determined using a known sound field.

### BRIEF DESCRIPTION OF DRAWINGS

FIG. 1 is a diagram illustrating a rendering architecture according to an embodiment.

FIG. 2 is a diagram illustrating a control workflow and a rendering workflow of an audio signal processing apparatus, according to various embodiments.

FIG. 3 is a diagram illustrating a renderer pipeline according to various embodiments.

FIG. 4 is a schematic block diagram of an electronic device according to various embodiments.

FIG. 5 is a flowchart of a method of determining an impulse response, according to various embodiments.

FIGS. 6 and 7 are diagrams illustrating extracted direct source components according to various embodiments.

FIGS. 8 and 9 are diagrams illustrating extracted early reflection according to various embodiments.

FIG. 10 is a diagram illustrating an operation of determining an impulse response at a position of a listener, according to various embodiments.

FIG. 11 is a diagram illustrating an operation of estimating a position of a source, according to various embodiments.

FIG. 12 is a diagram illustrating an operation of estimating a position of a source and a position of an image source, according to various embodiments.

FIG. 13 is a flowchart of a method of determining an impulse response, according to various embodiments.

FIG. 14 is a diagram illustrating an operation of determining a direction of arrival (DOA) and a time of arrival (TOA) of a position of a listener, according to various embodiments.

FIG. 15 is a schematic block diagram of an electronic device according to various embodiments.

### BEST MODE FOR CARRYING OUT THE INVENTION

The following structural or functional descriptions of embodiments described herein are merely intended for the purpose of describing the embodiments described herein and may be implemented in various forms. Here, the embodiments are not construed as limited to the disclosure and should be understood to include all changes, equivalents, and replacements within the idea and the technical scope of the disclosure.

Although terms of “first,” “second,” and the like are used to explain various components, the components are not limited to such terms. These terms are used only to distinguish one component from another component. For example, a first component may be referred to as a second component, or similarly, the second component may be referred to as the first component within the scope of the present disclosure.

It should be noted that if it is described that one component is “connected”, “coupled”, or “joined” to another component, a third component may be “connected”, “coupled”, and “joined” between the first and second components, although the first component may be directly connected, coupled, or joined to the second component.

The singular forms “a,” “an,” and “the” are intended to include the plural forms as well, unless the context clearly indicates otherwise. As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure pertains. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

As used in connection with the present disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The term “unit” used herein may refer to a software or hardware component, such as a field-programmable gate array (FPGA) or an ASIC, and the “unit” performs predefined functions. However, “unit” is not limited to software or hardware. The “unit” may be configured to reside on an addressable storage medium or configured to operate one or more processors. Accordingly, the “unit” may include, for example, components, such as software components, object-oriented software components, class components, and task components, processes, functions, attributes, procedures, sub-routines, segments of program code, drivers, firmware, microcode, circuitry, data, databases, data structures, tables, arrays, and variables. The functionalities provided in the components and “units” may be combined into fewer components and “units” or may be further separated into additional components and “units.” Furthermore, the components and “units” may be implemented to operate on one or more central processing units (CPUs) within a device or a security multimedia card. In addition, “unit” may include one or more processors.

Hereinafter, the embodiments will be described in detail with reference to the accompanying drawings. When describing the embodiments with reference to the accompanying drawings, like reference numerals refer to like elements and a repeated description related thereto will be omitted.

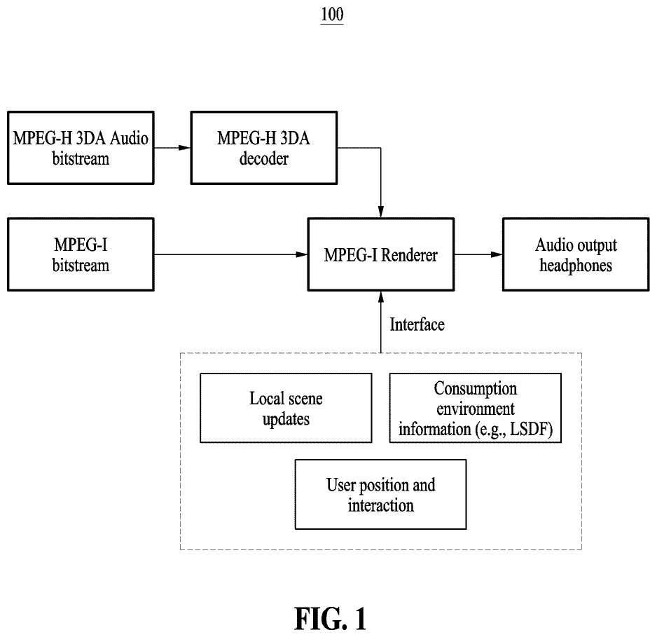

FIG. 1 is a diagram illustrating a rendering architecture 100 according to an embodiment.

In an example, a renderer (e.g., an MPEG-I Renderer of FIG. 1) may operate at a global sampling frequency of 48 kilohertz (kHz). Input pulse-code modulation (PCM) audio data using other sampling frequencies may be resampled to 48 KHz before processing.

FIG. 1 may show how the renderer is connected to external devices such as MPEG-H 3DA coded audio element bitstreams, metadata MPEG-I bitstreams, and other interfaces.

For example, the MPEG-H 3DA coded audio element (e.g., an MPEG-H 3DA audio bitstream) may be decoded by an MPEG-H 3DA decoder. The decoded audio may be rendered together with an MPEG-I bitstream. The MPEG-I bitstream may transmit an audio scene description and other metadata used by the renderer to the renderer. Additionally, the renderer may be input with an interface to access consumption environment information, scene updates during playback, user interaction, and user position information.

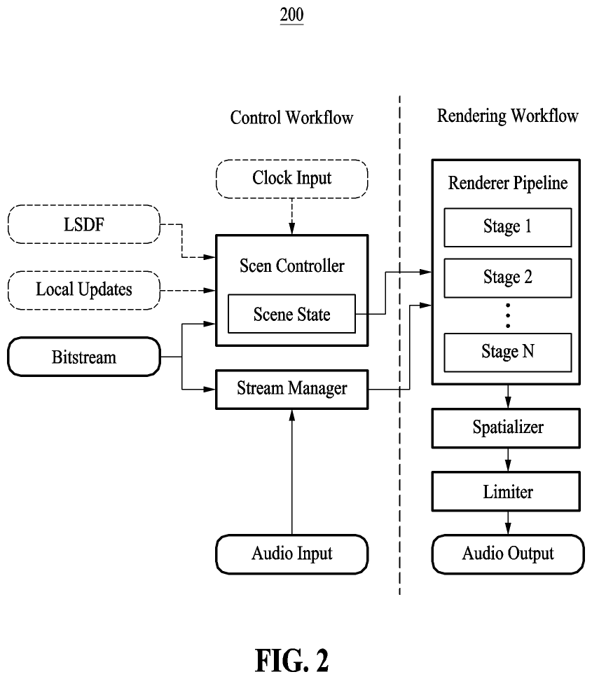

The renderer may provide real-time auralization of a six degrees of freedom (6-DoF) audio scene in which a user may directly interact with entities in the scene. For the real-time auralization of the 6-DoF audio scene, a multithreaded software architecture may be divided into several workflows and components. A block diagram including a renderer component may be shown in FIG. 2. The renderer may support rendering of virtual reality (VR) and augmented reality (AR) scenes. The renderer may obtain rendering metadata and audio scene information for VR and AR scenes from a bitstream. For example, in the case of an AR scene, the renderer may obtain listening space information for the AR scene as a listener space description format (LSDF) file during playback.

FIG. 2 is a diagram illustrating a control workflow and a rendering workflow 200 of an audio signal processing apparatus, according to various embodiments.

According to an embodiment, an audio signal processing apparatus may perform rendering on object audio using an object audio signal and metadata. For example, the audio signal processing apparatus may refer to a renderer.

For example, the audio signal processing apparatus may perform real-time auralization of 6-DoF audio scene in which a user may directly interact with entities in the audio scene. The audio signal processing apparatus may perform rendering on VR or AR scenes. In the case of VR or AR scenes, the audio signal processing apparatus may obtain metadata and audio scene information from a bitstream. In the case of an AR scene, the audio signal processing apparatus may obtain listening space information at which the user is positioned from an LSDF file.

As shown in FIG. 1, the audio signal processing apparatus may output audio through the control workflow and the rendering workflow.

The control workflow is an entry point of the renderer, and the audio signal processing apparatus may interface with an external system and component through the control workflow. The audio signal processing apparatus may adjust states of entities in the 6-DoF scene and implement a conversational interface using a scene controller in the control workflow.

The audio signal processing apparatus may control a scene state. The scene state may reflect current states of all scene objects including an audio element, transform/anchor, and geometry. The audio signal processing apparatus may generate all objects in the entire scene before rendering begins and update to a state in which metadata of all objects reflects a desired scene composition when playback begins.

The audio signal processing apparatus may provide an integrated interface for the renderer component to access an audio stream connected to an audio element in the scene state using a stream manager. The audio stream may be input as a printed circuit board (PCB) float sample. The source of the audio stream may be, for example, a decoded MPEG-H audio stream or local captured audio.

A clock may provide an interface for the renderer component and provide the current scene time in seconds. A clock input may be, for example, a synchronization signal of other sub-systems or an internal clock of the renderer.

The rendering workflow may generate an audio output signal. For example, the audio output signal may be a PCM float. The rendering workflow may be separated from the control workflow. The scene state for transferring all of the changes of the 6-DoF scene and the stream manager for providing an input audio stream may access the rendering workflow for the communication between the two workflows (the control workflow and the rendering workflow).

A renderer pipeline may auralize the input audio stream provided by the stream manager based on the current scene state. For example, rendering may be performed according to a sequential pipeline such that individual renderer stages implement an independent perceptual effect and use the processing of previous and subsequent stages.

A spatializer may terminate the renderer pipeline and auralize an output of the renderer stage to a single output audio stream suitable for a desired playback method (e.g., the binaural or loudspeaker playback).

A limiter may provide a clipping protection function for an audible output signal.

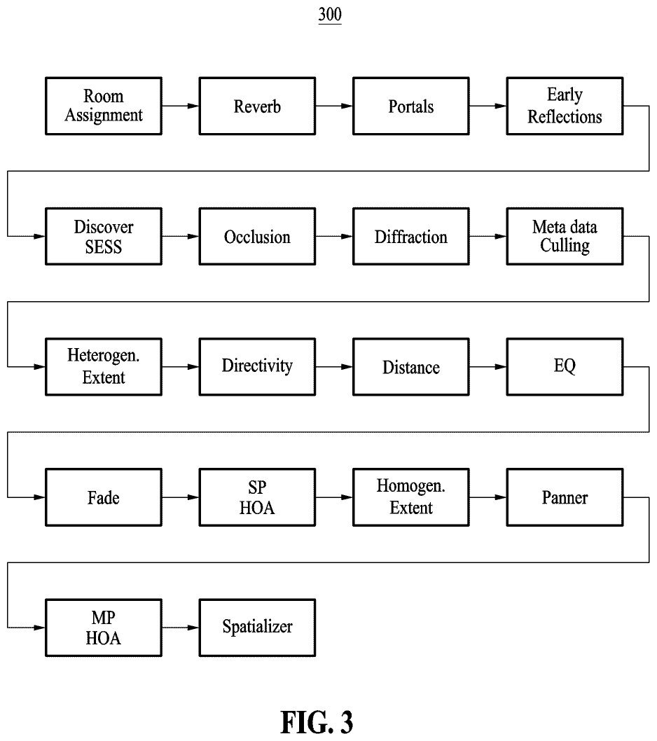

FIG. 3 is a diagram illustrating a renderer pipeline 300 according to various embodiments.

For example, each renderer stage of the renderer pipeline may be performed according to a set order. For example, the renderer pipeline may include stages of room assignment, reverb, portal, early reflection, discover spatially extended sound source (SESS), occlusion, diffraction, metadata culling, heterogeny. extent, directivity, distance, equalizer (EQ), fade, single point higher-order ambisonics (SP HOA), homogen. extent, panner, and multi point higher-order ambisonics (MP HOA).

For example, an audio signal processing apparatus may render a gain, propagation delay, and medium absorption of object audio, according to the distance between the object audio and a listener in the rendering workflow (e.g., the rendering workflow of FIG. 2). For example, the audio signal processing apparatus may determine at least one of a gain, propagation delay, and medium absorption of the object audio in the distance stage of the renderer pipeline.

In the distance stage, the audio signal processing apparatus may calculate a distance between each render item (RI) and the listener and may interpolate a distance between update routine calls of an object audio stream based on a constant velocity model. The RI may refer to all audio elements in the renderer pipeline.

The audio signal processing apparatus may apply the propagation delay to a signal related to the RI to generate a physically accurate delay and Doppler effect.

The audio signal processing apparatus may model a frequency-independent attenuation of the audio element due to the geometric diffusion of source energy, applying a distance attenuation. The audio signal processing apparatus may use a model considering the size of the source for the distance attenuation of a geometrically extended source.

The audio signal processing apparatus may apply the medium absorption to the object audio, by modeling a frequency-dependent attenuation of the audio element related to absorption features of air.

The audio signal processing apparatus may determine a gain of the object audio by applying the distance attenuation according to the distance between the object audio and the listener. The audio signal processing apparatus may apply the distance attenuation due to the geometric diffusion, using a parametric model considering the size of the source.

When the audio is played in the 6-DoF environment, a sound level of the object audio may vary depending on the distance, and the size of the object audio may be determined according to the 1/r law in which the size decreases in inverse proportion to the distance. For example, the audio signal processing apparatus may determine the size of the object audio according to the 1/r law in a region where the distance between the object audio and the listener is greater than a minimum distance and less than a maximum distance. The minimum distance and the maximum distance may refer to distances set to apply the attenuation, propagation delay, and atmospheric absorption effect according to the distance.

For example, the audio signal processing apparatus may identify a position of the listener (e.g., three-dimensional (3D) spatial information), a position of the object audio (e.g., the 3D spatial information), and the velocity of the object audio, using metadata. The audio signal processing apparatus may calculate the distance between the object audio and the listener, using the position of the listener and the position of the object audio.

The size of an audio signal transmitted to the listener may vary according to the distance between an audio source (e.g., the position of the object audio) and the listener. For example, in general, a sound level transmitted to the listener positioned at a distance of 2 meters (m) from the audio source may be less than the sound level transmitted to the listener positioned at a distance of 1 m from the audio source. In the free field environment, the sound level may be reduced by a ratio of 1/r (r is the distance between the object audio and the listener). When the distance between the source and the listener is doubled, the sound level heard by the listener may be reduced by about 6 decibels (dB).

The law about the attenuation of the distance and sound level may be applied to the 6-Dof VR environment. The audio signal processing apparatus may use a method of decreasing the size of one object audio signal when the distance is far from the listener and increasing the size of one object audio signal when the distance is close to the listener.

For example, assuming that a sound pressure level heard by the listener is 0 dB when the listener is 1 m away from the object audio, when the sound pressure level is changed to −6 dB when the listener is 2 m away from the object audio, the listener may feel that the sound pressure naturally decreases.

For example, when the distance between the object audio and the listener is greater than the minimum distance and less than the maximum distance, the audio signal processing apparatus may determine a gain of the object audio according to Equation 1 below. In Equation 1, a “reference_distance” denotes a reference distance and a “current_distance” denotes a distance between the object audio and the listener. The reference distance may refer to a distance at which the gain of the object audio is 0 dB and may be set differently for each object audio. For example, the metadata may include the reference distance of the object audio.

$$Gain [ dB ] = 20 log ( reference\_distance / current\_distance ) \qquad [ Equation 1 ]$$

For example, an RI may represent an acoustically active element in the scene. An RI may be directly derived from the primary, that is, from an audio element in the scene, or from the secondary, that is, from other RIs (e.g., reflection or diffracted paths). The properties of the RI may be as shown in Table 1 below.

TABLE 1

| | | | Default |
|---|---|---|---|
| Field name | Data type | Description | value |
| idx | const int | Unique identifier of the RI | — |
| status | ItemStatus | The status of the RI (see | — |
| | | ItemStatus type description) | |
| type | ItemType | The type of the RI (see ItemType | — |
| | | type description) | |
| changed | ItemProperty | Flags to mark changed properties | — |
| | | of the RI (see ItemProperty type | |
| | | description) | |
| aparams | AParam | Flags to mark special rendering | — |
| | | instructions for the RI (see AParam | |
| | | type description) | |
| reverbId | int | Identifier of the reverberation | −1 |
| | | environment this RI is located in | |
| | | (special value −1 if the RI is outside | |
| | | of all reverberation environments in | |
| | | the scene) | |
| trajectory | Trajectory | Optional constant-velocity | None |
| | | trajectory to interpolate the location | |
| | | of the RI between successive calls | |
| | | to the update( ) routine | |
| teleport | bool | Whether or not this RI should be | false |
| | | handled as teleported | |
| position | Position | The position (location and | — |
| | | orientation) of the RI in global | |
| | | coordinates (see Position type | |
| | | description) | |
| apparentDistanceDelta | float | Compensation for the distance to | 0 |
| | | the listener for synchronizing | |
| | | multiple Rls with different locations | |
| | | in terms of their propagation delay | |
| | | and distance attenuation | |
| refDistance | float | Reference distance for the distance | 1 |
| | | attenuation model | |
| signal | StreamBuffer | Reference to a StreamBuffer | — |
| | | instance (see Stream Manager | |
| | | section) | |
| eq | List<float> | Frequency-dependent gain for the | N × 1 |
| | | signal associated with this RI in | |
| | | globally defined bands (see | |
| | | Equalizer section) | |
| gain | float | Global frequency-independent gain | 1 |
| | | for the signal associated with this | |
| | | RI | |
| directivity | Directivity | Optional reference to a Directivity | None |
| | | representation for the RI (see | |
| | | Directivity type description) | |
| directiveness | float | Parameter to control the frequency- | 1 |
| | | independent intensity of the | |
| | | Directivity | |
| extent | Geometry | Optional reference to a Geometry | None |
| | | that describes the extent of the RI | |
| extentLayout | ExtentLayout | Reference to the channel layout of | None |
| | | a heterogeneous extended source | |
| rayHits | List<RayHit> | Data structure to aid the processing | Empty |
| | | of extended sources (see | |
| | | respective stages) | |
| reflectionInfo | ReflectionInfo | Optional reference to a special | None |
| | | struct that contains information | |
| | | about the reflection path this RI | |
| | | represents (see error! reference | |
| | | source not found.) | |
| occlusionInfo | OcclusionInfo | Optional reference to a special | None |
| | | struct that contains information | |
| | | about the occlusion of this RI (see | |
| | | error! Reference source not found.) | |
| channelPositions | List<Position> | | None |
| hoalnfo | Hoalnfo | Optional reference to a special | None |
| | | struct that contains information | |
| | | about the HOA source this RI | |
| | | represents (seeError! Reference s | |
| | | ource not found.) | |

For example, an RI may include ItemStatus. ItemStatus may be processed as an active status in the renderer stage. When ItemStatus is different from the status of the previous update (update ( )) call, a changed flag may be set according to the changed status of ItemStatus.

For example, an RI may include ItemType. When ItemType is a primary, it may represent that the RI is directly derived from a scene object. When ItemType is reflection, it may represent that the RI is a secondary RI derived from specular reflection of other RIs. When ItemType is a diffraction, it may represent that the RI is a secondary RI derived from a geometrically diffracted path of other RIs.

For example, an RI may include a position of the source, a directional room impulse response (DRIR) at a first position, and a DRIR at a second position. For example, the position of the source may be estimated using the DRIR at the first position and the DRIR at the second position.

The DRIR at a position of the listener may be calculated based on the position of the source. For example, a direction of arrival (DOA) and a time of arrival (TOA) at the position of the listener may be calculated using the position of the source and the position of the listener. The DRIR at the position of the listener may be calculated by interpolating the DRIR at the first position and/or the DRIR at the second position, depending on the DOA and TOA at the position of the listener.

To synthesize a spatial sound for an application such as VR, realistic 3D sound may need to be played back dynamically through headphones or other playback systems. This may be called 6-DoF audio. The realistic 3D sound may need to accurately reproduce the direction of the source and the reverb features of a room. In the VR application, the reproduction of 3D sound may be typically achieved by convoluting a DRIR with a desired dry source signal prior to binaural playback through headphones. To ensure a seamless experience each time a user moves in the virtual environment, a new 3D audio scene may need to be generated and the DRIR may need to be regularly updated to match a new listening position to the position of the source.

First-order ambisonics (FOA) encoding of a room impulse response (RIR) may be used to generate a DRIR. A DRIR at a known position (e.g., the first position and the second position) may be analyzed to extract a specular source (e.g., a direct source and specular early reflection) at the known position.

When DOA information of the specular source is calculated, an electronic device according to an embodiment may determine a position of an audio source (the source), using interpolation. For example, the electronic device may determine the position of the audio source using triangulation. Based on the known DRIR and depending on the position of the audio source, the electronic device may estimate spatial information (the azimuth and elevation) of the direct source at the new listening position.

The electronic device may obtain the spatial information (the azimuth and elevation) of reflected light early reflection at the new listening position by triangulating a position of an image source, based on the informed DRIR.

According to various embodiments, the electronic device may estimate the DRIR of the new listening position, using a known DRIR signal at two positions. The electronic device may decompose the known DRIR into a specular source and a diffuse component. The specular source may be further decomposed into the direct source and specular early reflection. The electronic device may estimate the position of the audio source by triangulation, based on the known DRIR, and may estimate the spatial information (the azimuth and elevation) of the direct source at the new listening position. When the position of the audio source is estimated, the electronic device may calculate the spatial information of the audio source for the new listening position.

Similar to the direct source, the electronic device may calculate the position of the image source. The electronic device may estimate the position of the audio source and may calculate the spatial information of the audio source for the new listening position. The electronic device may calculate the position of the image source according to triangulation from the specular early reflection of the known DRIR. The electronic device may estimate the spatial information (the azimuth and elevation) of the specular early reflection at the new listening position for the image source.

After calculating the spatial information of the new listening position, the electronic device may determine the DRIR at the new listening position by merging the estimated spatial information with the estimated rotation property according to the head direction of the listener.

The electronic device and method of determining an impulse response according to various embodiments may triangulate a real source and the image source according to the DRIR interpolation method that may estimate the spatial property of the interpolated reflection (direct and early) source.

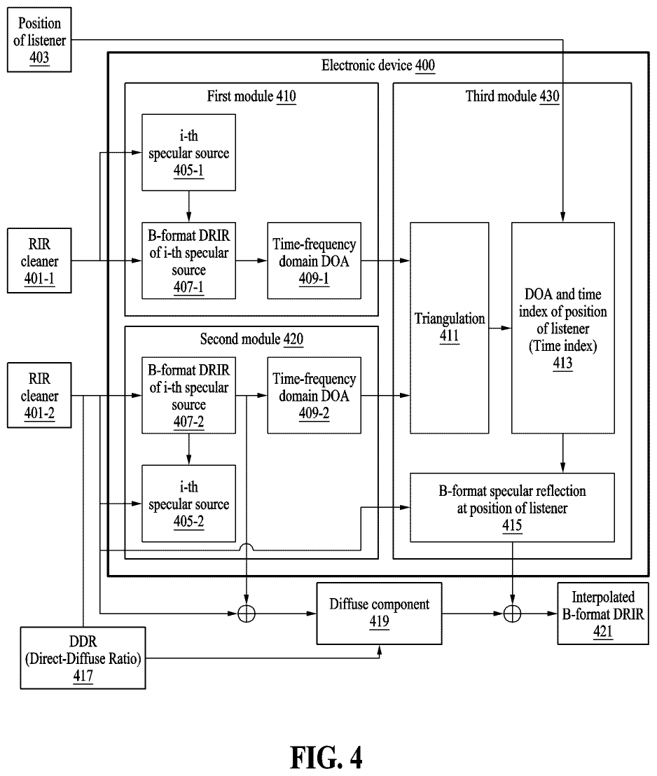

FIG. 4 is a schematic block diagram of an electronic device 400 according to various embodiments.

The electronic device 400 may remove a direct current (DC) component of B-format DRIR, using RIR cleaners 401-1 and 401-2. The RIR cleaners 401-1 and 401-2 may be set to high-pass filters (HPFs) in which a cut-off frequency is set to 20 Hz, which is the minimum audible frequency by a human listening system. 4-channel B-format DRIR may be normalized by removing a silent part. For example, an impulse response (e.g., the B-format DRIR) at the first position may be input to the RIR cleaner 401-1 and an impulse response at the second position may be input to the RIR cleaner 401-2.

The electronic device 400 may identify i-th specular sources 405-1 and 405-2, using a W channel of the B-format DRIR output from the RIR cleaners 401-1 and 401-2. The electronic device 400 may determine B-format DRIRs of i-th specular sources 407-1 and 407-2, using a time index at which the i-th specular source is identified and the B-format DRIR output from the RIR cleaners 401-1 and 401-2.

The electronic device 400 may obtain time-frequency domain DOAs 409-1 and 409-2, by calculating DOA information of a divided B-format specular source using the B-format DRIRs of the i-th specular sources 407-1 and 407-2.

The electronic device 400 may analyze the spatial information of known B-format DRIR to estimate the positions of the direct source and image source by a triangulation method. The electronic device 400 may calculate the positions of the direct source and image source, by performing triangulation 411 on the time-frequency domain DOAs 409-1 and 409-2.

The electronic device 400 may calculate a DOA and a time index of a position of a listener 413, using the positions of the direct source and image source. The electronic device 400 may calculate the spatial information of the specular source for the new listening position, using the positions of the direct source and image source.

The electronic device 400 may synthesize the W channel of the B-format DRIR at the known position with the spatial information of the specular source for the new listening position. The electronic device 400 may calculate B-format specular reflection at a position of a listener 415, by synthesizing the W channel of the B-format DRIR at the known position with the spatial information of the specular source for the new listening position.

The electronic device 400 may calculate an interpolated B-format DRIR 421, using the B-format specular reflection at the position of the listener 415 and a diffuse component 419. The diffuse component 419 may be calculated using the 4-channel B-format DRIR and the B-format DRIR of the i-th specular source 407-2, according to a direct-diffuse ratio (DDR) 417.

As described above, a first module 410 and a second module 420 may respectively predict the time-frequency domain DOAs 409-1 and 409-2, using the B-format DRIR. A third module 430 may predict the position of the source by performing the triangulation 411 on the time-frequency domain DOAs 409-1 and 409-2 and may calculate the DOA and the time index of the position of the listener 413. The third module 430 may calculate the B-format specular reflection at the position of the listener 415, using the DOA and the time index of the position of the listener 413.

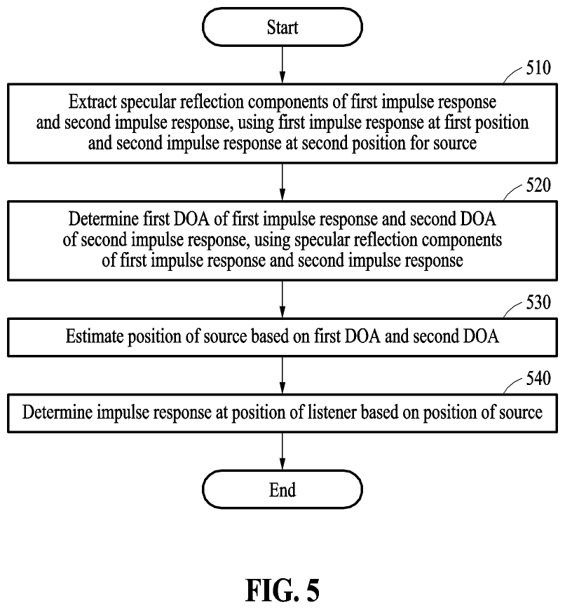

FIG. 5 is a flowchart of a method of determining an impulse response, according to various embodiments.

In operation 510, the electronic device 400 may extract specular reflection components of a first impulse response and a second impulse response, using the first impulse response at the first position and the second impulse response at the second position for the source.

The electronic device 400 may separate an FOA signal into a specular reflection component and a diffuse component.

A sound recorded at a position Lₘ(xₘ, yₘ, zₘ) in a noise-free environment may be expressed as Equation 2 below.

$${p}_{{L}_{m}} = {\sum }_{j = 0}^{J - 1} {s}_{{L}_{j}} * {h}_{{L}_{j} \to {L}_{m}} \qquad [ Equation 2 ]$$

In Equation 2, s_{L}_{ⱼ} denotes a source generated at a position Lⱼ=(xⱼ, yⱼ, zⱼ) and h_{L}_{ⱼ}_{→L}_{ₘ} denotes an RIR corresponding between a position Lⱼ of a source and a position Lₘ of recording. The RIR may be modeled as the sum of the specular reflection (direct source and early reflection) and the delay response (diffuse), as shown in Equation 3 below.

$$h = {h}_{specular} + {h}_{late} = {h}_{dir} + {h}_{early} + {h}_{late} \qquad [ Equation 3 ]$$

In Equation 3, h_{specular} denotes the specular reflection, hate denotes the delay response, h_{dir} denotes the direct source, and h_{early} denotes the early reflection.

In Equation 3, h_{specular} denotes a component of the RIR due to the specular reflection and substantially the same description may be applied to the hₗₐₜₑ, h_{dir}, h_{early}.

The electronic device 400 may estimate the component of the RIR at a certain position, in Equation 3 above. For example, an input signal (e.g., the first impulse response and the second impulse response) may include the B-format DRIR and the B-format DRIR may include an omnidirectional channel W and three mutually perpendicular figure-of-eight channels X, Y, and Z. The B-format DRIR may be obtained through simulation or by converting a measured A-format DRIR into a spatial microphone.

$$\{ \begin{matrix}{h}_{W} = \frac{1}{√ 2} ( {h}_{FLU} + {h}_{FRD} + {h}_{BLD} + {h}_{BRU} ) \\ {h}_{X} = {h}_{FLU} + {h}_{FRD} - {h}_{BLD} - {h}_{BRU} \\ {h}_{Y} = {h}_{FLU} - {h}_{FRD} + {h}_{BLD} - {h}_{BRU} \\ {h}_{Z} = {h}_{FLU} - {h}_{FRD} - {h}_{BLD} + {h}_{BRU}\end{matrix} \qquad [ Equation 4 ]$$

In Equation 4, FLU, FRD, BLD, and BRU denote four cardioid capsules of a sound field microphone facing front left up, front right down, back left down, and back right up, respectively.

The electronic device 400 may identify the specular source in operation 510. The electronic device 400 may analyze an input signal and find a short segment of a signal including a peak. For example, the electronic device 400 may analyze the W channel of the B-format DRIR and find a short segment of a signal including a local peak that is compared with an energy threshold value.

For example, the electronic device 400 may separate a specular component similar to an impulsive noise component of the RIR and a diffuse component similar to a noise signal, by comparing output power from two tracking filters. The tracking filter may include a fast tracker filter that is applied to a short segment and a slow tracker filter that is applied to a long segment.

The electronic device 400 may compare output power of the RIR, as shown in Equation 5 below.

$${P}_{w}^{fast} ( n ) = {P}_{w} ( n ) * {H}_{fast} ( n ) \qquad [ Equation 5 ]$$

$${P}_{w}^{slow} ( n ) = {P}_{w} ( n ) * {H}_{slow} ( n )$$

In Equation 5 above, P_{w}(n)=W_{L}_{ₘ}(n)² denotes power of a W channel of a DRIR signal, (*) denotes a convolution operator, H_{fast}(n) denotes a filter (e.g., the fast tracker filter) that derives power in the short-term based on a time n, H_{slow}(n) denotes a filter (e.g., the slow tracker filter) that derives power in the short-term based on the time n.

The approach method of separating the specular reflection component and the diffuse component, according to Equation 5 above, may be more suitable assuming that the early specular reflection is appropriately separated in time.

In Equation 5 above, H_{fast}(n), H_{slow}(n) may be defined as Equation 6 below.

$${H}_{fast} ( n ) = \frac{win ( n )}{\sum win ( n )} n = 0 to {τ}_{fast} \cdot fs \qquad [ Equation 6 ]$$

$${H}_{slow} ( n ) = \frac{win ( n )}{\sum win ( n )} n = 0 to {τ}_{slow} \cdot fs$$

In Equation 6 above, τ_{fast} and, τ_{slow} may be set to, for example, τ_{fast}=0.0003, τ_{slow}=0.002, respectively

The electronic device 400 may find the specular reflection by calculating the power difference between the fast tracker filter and the slow tracker filter. The electronic device 400 may calculate the power difference between the fast tracker filter and the slow tracker filter, as shown in Equation 7 below.

$${R}_{dB} ( n ) = 10 * {log}_{10} \frac{{P}_{w}^{fast} ( n )}{{P}_{w}^{slow} ( n )} \qquad [ Equation 7 ]$$

The electronic device 400 may find a time

$$n = {n}_{peak}^{i}$$

at which a peak of the specular reflection is detected. For example, when R_{dB}(n) is greater than a preset threshold value α (e.g., 6 dB), the electronic device 400 may find the peak

$${n}_{peak}^{i}$$

at which the specular reflection is detected. When R_{dB}(n) is a local maximum, the electronic device 400 may find the peak

$${n}_{peak}^{i}$$

at which the specular reflection is detected. When P_{w}(n) is greater than a preset threshold value β (e.g., −50 dB), the electronic device 400 may find the peak

$${n}_{peak}^{i}$$

at which the specular reflection is detected. For example, the threshold value β is for distinguishing a peak from noise and may be determined depending on a noise level of a certain RIR.

When R_{dB}(n) is greater than the preset threshold value α and is the local maximum, and P_{w}(n) is greater than the preset threshold value β, the electronic device 400 may find the peak

$${n}_{peak}^{i}$$

at which the specular reflection is detected.

The electronic device 400 may extract a specular reflection signal

$${W}_{spec , {L}_{m}}^{i} ( n )$$

from a sample

$${W}_{{L}_{m}} ( {n}_{s}^{i} ) .$$

The electronic device 400 may extract a region where R_{dB}(n) is greater than a preset threshold value γ (e.g., 4 dB) as the specular reflection signal

$${W}_{s p e c , {L}_{m}}^{i} ( n ) ,$$

around a position (e.g., around

$$n = {n}_{peak}^{i} )$$

of the specular reflection peak of the sample

$${W}_{{L}_{m}} ( {n}_{s}^{i} ) .$$

For example, the threshold value γ may determine a length of the specular reflection in the time domain.

The specular reflection signal

$${W}_{s p e c , {L}_{m}}^{i} ( n )$$

may be expressed as Equation 8 below.

$${W}_{s p e c , {L}_{m}}^{i} ( n ) = {W}_{{L}_{m}} ( {n}_{s}^{i} ) \qquad [ Equation 8 ]$$

In Equation 8,

$${n}_{s}^{i} = [ {n}_{peak}^{i} - {n}_{s p e c}^{i} , and {n}_{peak}^{i} + {n}_{s p e c}^{i} ] ( i = 1 , 2 , … , M ) ,$$

$${n}_{peak}^{i}$$

denotes a peak detected in the i-th specular reflection signal

$${W}_{spec , {L}_{m}}^{i} ( n ) .$$

M denotes the number set to extract the specular reflection signal and

$${n}_{spec}^{i}$$

denotes a preset time.

As described above, the electronic device 400 may obtain the specular reflection signal using a segment of a DRIR of a j-th source.

As shown in Equation 9, the electronic device 400 may derive a diffuse signal

$${W}_{diff , {L}_{m}}^{i} ( n ) ,$$

by removing all specular components W_{spec,L}_{ₘ}(n).

$${W}_{diff , {L}_{m}} ( n ) = {W}_{{L}_{m}} ( n ) - {W}_{spec , {L}_{m}} ( n ) \qquad [ Equation 9 ]$$

In Equation 9, for

$$n = {n}_{s}^{i}$$

in every i,

$${W}_{spec , j} ( n , {L}_{m} ) = {W}_{spec , j}^{i} ( n , {L}_{m} ) ,$$

and for

$$n \neq {n}_{s}^{i} , {W}_{s p e c , j} ( n , {L}_{m} ) = 0 .$$

For example, when

$${n}_{peak}^{i + 1} - {n}_{peak}^{i} < σ ,$$

the electronic device 400 may not treat an extracted segment as an individual specular reflection component but as a diffuse component. σ denotes a preset threshold value. When each peak is separated to be greater than or equal to the threshold value σ, the electronic device 400 may extract the specular reflection component (or the specular reflection signal) according to each peak.

In operation 520, the electronic device 400 may determine a first DOA of the first impulse response and a second DOA of the second impulse response, using the specular reflection components of the first impulse response and the second impulse response. For example, the first DOA and the second DOA may each include the azimuth and elevation at which a sound signal is input from the source.

The electronic device 400 may separate an extracted specular reflection signal into the individual specular reflection signal

$${W}_{spec , j}^{i} ( n , {L}_{m} ) .$$

The electronic device 400 may determine a new FOA signal for an image source from a 4-channel FOA signal.

The electronic device 400 may determine an FOA signal corresponding to the specular reflection, for a given sound source j (represented as i), as shown in Equation 10 below.

$$( {X}_{spec , j}^{i} ( n , {L}_{m} ) , {Y}_{spec , j}^{i} ( n , {L}_{m} ) , {Z}_{spec , j}^{i} ( n , {L}_{m} ) , {W}_{spec , j}^{i} ( n , {L}_{m} ) ) \qquad [ Equation 10 ]$$

In Equation 10,

$${W}_{spec , j}^{i} ( n , {L}_{m} )$$

denotes the specular reflection signal calculated according to Equation 8 and

$${X}_{spec , j}^{i} ( n , {L}_{m} ) , {Y}_{s p e c , j}^{i} ( n , {L}_{m} ) , and {Z}_{spec , j}^{i} ( n , {L}_{m} )$$

denote X, Y, and Z channel signals extracted by the same sample and method corresponding to

$${W}_{spec , j}^{i} ( n , {L}_{m} ) ,$$

respectively.

The electronic device 400 may convert Equation 10 into the time-frequency domain using short-term Fourier-transform (STFT) and may calculate Equation 11 below.

$$( {X}_{spec , j}^{i} ( n , k , {L}_{m} ) , {Y}_{s p e c , j}^{i} ( n , k , {L}_{m} ) , {Z}_{spec , j}^{i} ( n , k , {L}_{m} ) , {W}_{s p e c , j}^{i} ( n , k , {L}_{m} ) ) \qquad [ Equation 11 ]$$

In Equation 11, k denotes a discrete frequency, and Equation 11 may be expressed as

$$( {X}_{j , m}^{i} , {Y}_{j , m}^{i} , {Z}_{j , m}^{i} , {W}_{j , m}^{i} ) .$$

For example, a fast fourier transform FFT with a length of 1024 that overlaps a Kaiser-Bessel Derived window by 50% may be used.

The electronic device 400 may calculate the azimuth azimuth

$${θ}_{j}^{i} ( n , k , {L}_{m} )$$

and elevation

$${ϕ}_{j}^{i} ( n , k , {L}_{m} )$$

of a time-frequency n,k, as shown in Equation 12 below.

$${θ}_{j}^{i} ( n , k , {L}_{m} ) = {tan}^{- 1} ( \frac{Re \{ {W}_{j , m}^{i} \cdot {Y}_{j , m}^{i} \}}{Re \{ {W}_{j , m}^{{i}^{*}} \cdot {X}_{j , m}^{i} \}} ) , {ϕ}_{j}^{i} ( n , k , {L}_{m} ) = {tan}^{- 1} ( \frac{- Re \{ {W}_{j , m}^{{i}^{*}} \cdot {Z}_{j , m}^{i} \}}{\sqrt{Re {\{ {W}_{j , m}^{{i}^{*}} \cdot {X}_{j , m}^{i} \}}^{2} + Re {\{ {W}_{j , m}^{{i}^{*}} \cdot {Y}_{j , m}^{i} \}}^{2}}} ) \qquad [ Equation 12 ]$$

The electronic device 400 may calculate the azimuth and elevation as described above for each extracted specular reflection signal and may repeatedly perform the above-described calculation for the set number M of specular reflection signals.

Since the energy of high frequency is generally lower than that of low frequency, the electronic device 400 may apply a weight to the time-frequency DOA to form a single DOA pair (e.g., an azimuth and elevation pair) in a given frame.

The electronic device 400 may use a DOA histogram approach method to determine the final estimate of the DOA for the image source. The electronic device 400 may derive a weight function for the azimuth and elevation component in the time-frequency domain. The weight may be based on the total energy ratio and W channel corresponding to the time-frequency.

The electronic device 400 may derive the weight, as shown in Equation 13 below.

$$Weight ( n , k , {L}_{m} ) = \frac{{W}_{j , m}^{i} * {W}_{j , m}^{{i}^{*}}}{\sum ( {W}_{j , m}^{i} * {W}_{j , m}^{{i}^{*}} )} \qquad [ Equation 13 ]$$

The electronic device 400 may predict the final DOA using the weighted sum of the azimuth and elevation for all frequencies k, as shown in Equation 14 below.

$${θ}_{j}^{i} ( n , {L}_{m} ) = {\sum }_{k} Weight ( n , k , {L}_{m} ) \cdot {θ}_{j}^{i} ( n , k , {L}_{m} ) {ϕ}_{j}^{i} ( n , {L}_{m} ) = {\sum }_{k} Weight ( n , k , {L}_{m} ) \cdot {ϕ}_{j}^{i} ( n , k , {L}_{m} ) \qquad [ Equation 14 ]$$

The electronic device 400 may predict the DOA according to Equation 14, and thus, the prediction accuracy may be improved compared to calculating the DOA in the time domain. In particular, when the specular reflection is affected by mid-level noise (causing incomplete separation of the DRIR into the individual specular reflection) or other interfering materials, the prediction accuracy of the predicted DOA according to Equation 14 may be improved.

The electronic device 400 may repeatedly perform the operation of predicting the DOA until the set number of specular sources (or peaks) are extracted.

As described above, in operation 520, the electronic device 400 may analyze the DRIR of each position L₁ and L₂ and may find an FOA-encoded direct source and image source.

In operation 530, the electronic device 400 may estimate the position of the source, based on the first DOA and the second DOA.

The electronic device 400 may predict DOAs of a direct sound and image source at each position L₁ and L₂. For example, the predicting of the DOA of the direct sound may refer to predicting the position of the direct source (or the source).

The electronic device 400 may interpolate a DOA and a relative TOA at the new position of a listener, using an FOA signal of the direct sound and image source, and the predicted DOA.

The electronic device 400 may determine an interpolated FOA signal Bⱼ(n, L_{I}) by synthesizing the specular reflection signal with the diffuse signal.

The electronic device 400 may find the position of the specular source using triangulation. For example, it may be assumed that 3D coordinate positions Bⱼ(t, L₁) (e.g., (x₁, y₁, z₁)) and Bⱼ(t, L₂) (e.g., (x₂, y₂, z₂)) for measuring are known and the position of the source is unknown.

The electronic device 400 may determine x₀, y₀ for the horizontal plane of the position Lⱼ=(xⱼ, yⱼ, zⱼ) of the source, using Equation 15 below. Below, α₁, β₁ denote a predicted DOA (e.g., the azimuth and elevation pair) at the position L₁ and α₂, β₂ denote a predicted DOA (e.g., the azimuth and elevation pair) at the position L₂.

$$tan {α}_{1} = \frac{{x}_{1} - {x}_{0}}{{y}_{1} - {y}_{0}} tan {α}_{2} = \frac{{x}_{2} - {x}_{0}}{{y}_{2} - {y}_{0}} \qquad [ Equation 15 ]$$

Accordingly, the electronic device 400 may calculate the position of the source, as shown in Equation 16 below.

$${x}_{0} = \frac{{y}_{2} - {y}_{1} - ( tan ( {α}_{2} ) \cdot {x}_{2} - tan ( {α}_{1} ) \cdot {x}_{1} )}{tan ( {α}_{1} ) - tan ( {α}_{2} )} {y}_{0} = tan ( {α}_{1} ) \cdot {x}_{0} - tan ( {α}_{1} ) \cdot x + {y}_{1} {z}_{0} = \{ \begin{matrix}{z}_{1} + tan ( {β}_{1} ) \cdot \sqrt{{( {x}_{1} - {x}_{0} )}^{2} + {( {y}_{1} - {y}_{0} )}^{2}} , & {β}_{1} > 0 \\ {z}_{1} - tan ( {β}_{1} ) \cdot \sqrt{{( {x}_{1} - {x}_{0} )}^{2} + {( {y}_{1} - {y}_{0} )}^{2}} , & otherwise\end{matrix} \qquad [ Equation 16 ]$$

The electronic device 400 may calculate a distance between the source and two FOA microphones (e.g., the position L₁ and the position L₂), as shown in Equation 17 below.

$${d}_{1}^{2} = {( {x}_{1} - {x}_{0} )}^{2} + {( {y}_{1} - {y}_{0} )}^{2} + {( {z}_{1} - {z}_{0} )}^{2} {d}_{2}^{2} = {( {x}_{2} - {x}_{0} )}^{2} + {( {y}_{2} - {y}_{0} )}^{2} + {( {z}_{2} - {z}_{0} )}^{2} \qquad [ Equation 17 ]$$

In Equations 15 to 17, x₀, y₀, z₀ denote the position of the source.

The electronic device 400 may repeat the calculations of Equations 15 to 17 to find the estimated DOA of the image source and may use the estimated DOA of the corresponding image source at each measurement position. To ensure that the same image source is being used at each measurement position, based on information that is assumed about the spatial magnitude, assuming that an image source corresponding to the early reflection reaching each FOA recording position (e.g., the position L₁ and the position L₂) in the similar time interval, the DOA for the image source may be selected.

In operation 540, the electronic device 400 may determine the impulse response at the position of the listener based on the position of the source.

The electronic device 400 may find the spatial information of the specular source at the new listening position.

The electronic device 400 may calculate the interpolated azimuth and elevation αₑ, βₑ at the new listening position, using the position of the source, as shown in Equation 18 below.

$${α}_{e} = arc tan ( \frac{{y}_{e} - {y}_{0}}{{x}_{e} - {x}_{0}} ) {β}_{e} = arc tan ( \frac{{z}_{e} - {z}_{0}}{{( {x}_{e} - {x}_{0} )}^{2} + {( {y}_{e} - {y}_{0} )}^{2} + {( {z}_{e} - {z}_{0} )}^{2}} ) \qquad [ Equation 18 ]$$

In Equation 18, xₑ, yₑ, zₑ denote x, y, and z coordinates in 3D space at the new listening position, respectively.

The electronic device 400 may determine the B-format DRIR of each specular source using the W channel of the separated specular source, as shown in Equation 19 below.

$$\{ \begin{matrix}{h}_{{W}_{e}^{s}} = \frac{{h}_{{W}_{1}^{s}}}{\sqrt{2}} \\ {h}_{{X}_{e}^{s}} = {h}_{{W}_{1}^{s}} \cdot cos ( {α}_{e} ) \cdot cos ( {β}_{e} ) \\ {h}_{{Y}_{e}^{s}} = {h}_{{W}_{1}^{s}} \cdot sin ( {α}_{e} ) \cdot cos ( {β}_{e} ) \\ {h}_{{Z}_{e}^{s}} = {h}_{{W}_{1}^{s}} \cdot sin ( {β}_{e} )\end{matrix} \qquad [ Equation 19 ]$$

The electronic device 400 may calculate the time delay of each specular source for the direct source at the new listening position using the path difference between the direct sound and image sound (or the reflection sound), as shown in Equation 20 below.

$${t}_{delay} = ( \sqrt{{( {x}_{e} - {x}_{i} )}^{2} + {( {y}_{e} - {y}_{i} )}^{2} + {( {z}_{e} - {z}_{i} )}^{2}} - \sqrt{{( {x}_{e} - {x}_{d} )}^{2} + {( {y}_{e} - {y}_{d} )}^{2} + {( {z}_{e} - {z}_{d} )}^{2}} ) \cdot \frac{fs}{c} \qquad [ Equation 20 ]$$

In Equation 20, x_{d}, y_{d}, z_{d} denote a position of the direct source, xᵢ, yᵢ, zᵢ denote a position of the image source, xₑ, yₑ, zₑ denote a position of the listener, fₛ denotes a sample rate, and c denotes the velocity of sound propagation in the air.

The electronic device 400 may predict the B-format DRIR at the position of the listener by connecting the specular B-format DRIR for which the time delay is compensated for.

The electronic device 400 may combine the interpolated specular B-format DRIR with the diffuse component. Since diffusion is generally considered non-directional, the electronic device 400 may combine a diffusion component of an input signal with the interpolated specular B-format DRIR.

The electronic device 400 may calculate a DDR using an input signal (e.g., the first impulse response or the second impulse response), as shown in Equation 21 below.

$$\overline{DDR} = \frac{1}{N} {\sum }_{i = 1}^{N} \frac{\sum {h}_{{w}_{i}^{s}} \cdot {h}_{{w}_{i}^{s}}}{\sum ( ( {h}_{{w}_{i}} - {h}_{{w}_{i}^{s}} ) \cdot ( {h}_{{w}_{i}} - {h}_{{w}_{i}^{s}} ) )} \qquad [ Equation 21 ]$$

The electronic device 400 may calculate the interpolated B-format DRIR at the position of the listener, as shown in Equation 22 below.

$$\{ \begin{matrix}{h}_{{W}_{e}} = {h}_{{W}_{e}^{s}} + {h}_{{W}_{1}^{D}} \cdot g \\ {h}_{{X}_{e}} = {h}_{{X}_{e}^{s}} + {h}_{{X}_{1}^{D}} \cdot g \\ {h}_{{Y}_{e}} = {h}_{{Y}_{e}^{s}} + {h}_{{Y}_{1}^{D}} \cdot g \\ {h}_{{Z}_{e}} = {h}_{{Z}_{e}^{s}} + {h}_{{Z}_{1}^{D}} \cdot g\end{matrix} \qquad [ Equation 22 ]$$

$$where g = \sqrt{\frac{{h}_{{W}_{e}^{s}} \cdot {h}_{{W}_{e}^{s}}}{{h}_{{W}_{1}^{D}} \cdot {h}_{{W}_{1}^{D}} \cdot \overline{DDR}}}$$

In Equation 22,

$${h}_{{W}_{1}^{D}} , {h}_{{X}_{1}^{D}} , {h}_{{Y}_{1}^{D}} , {h}_{{Z}_{1}^{D}}$$

denote diffusion components of W, X, Y, and Z channels of the input signal (e.g., the first impulse response or the second impulse response), respectively. For example,

$${h}_{{W}_{1}^{D}} , {h}_{{X}_{1}^{D}} , {h}_{{Y}_{1}^{D}} , {h}_{{Z}_{1}^{D}}$$

may be calculated by subtracting the B-format DRIR of the specular source (e.g., the B-format DRIR signal of the specular source calculated according to Equation 10) from the input signal (e.g., the B-format DRIR).

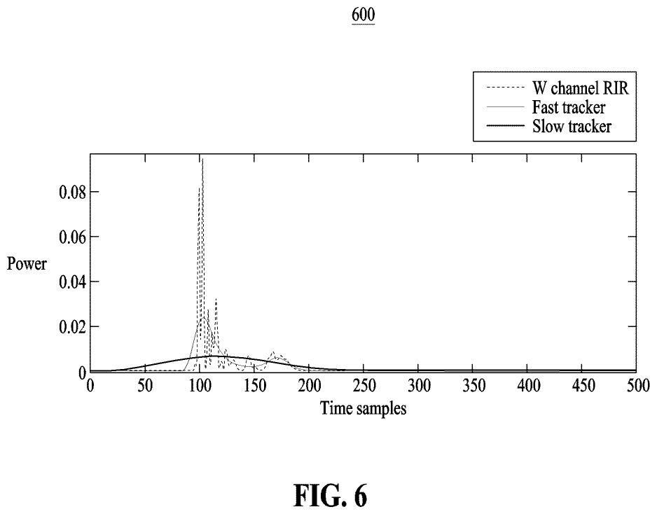

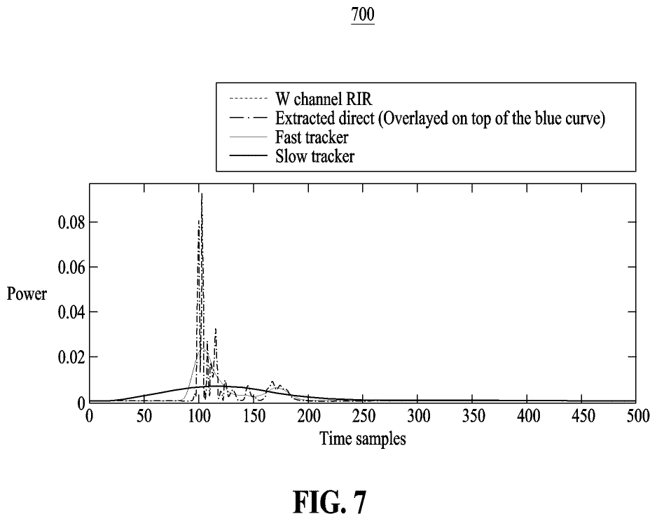

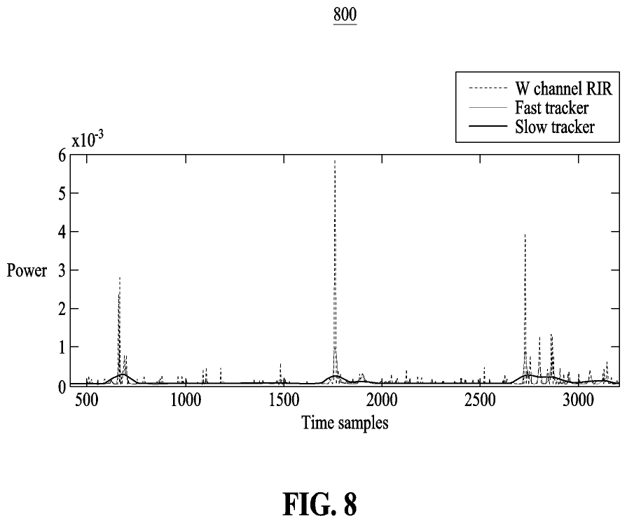

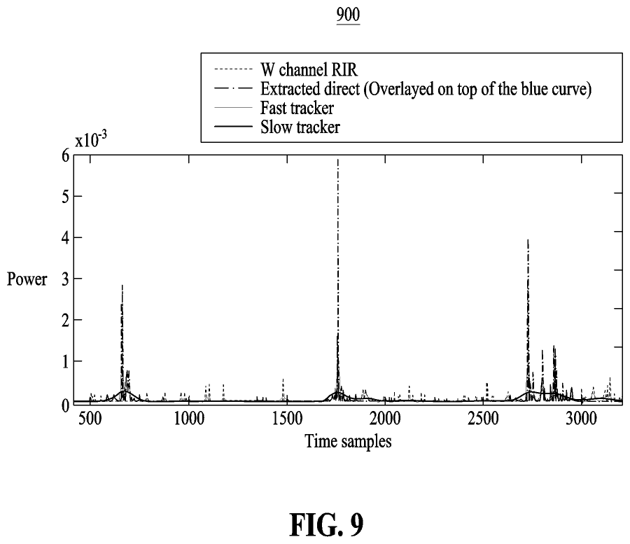

FIGS. 6 and 7 are diagrams illustrating extracted direct source components according to various embodiments. FIGS. 8 and 9 are diagrams illustrating extracted early reflection according to various embodiments.

As shown in FIGS. 6 and 7, the electronic device 400 may extract direct source components from the W channel of the B-format DRIR. FIG. 6 shows the W channel RIR, power to which the fast tracker filter is applied, and power to which the slow tracker filter is applied. FIG. 7 shows the W channel, power applied with the fast tracker filter, power applied with the slow tracker filter, and extracted direct source components.

As shown in FIGS. 8 and 9, the electronic device 400 may extract the early reflection from the W channel of the B-format DRIR. FIG. 8 shows the W channel of the RIR, power applied with the fast tracker filter, and power applied with the slow tracker filter, and FIG. 9 shows the W channel of the RIR, power applied with the fast tracker filter, power applied with the slow tracker filter, and the specular early reflection (or the early reflection and specular reflection). FIGS. 8 and 9 show examples of extracting the early reflection from the RIR that is the same as the RIR shown in FIGS. 6 and 7.

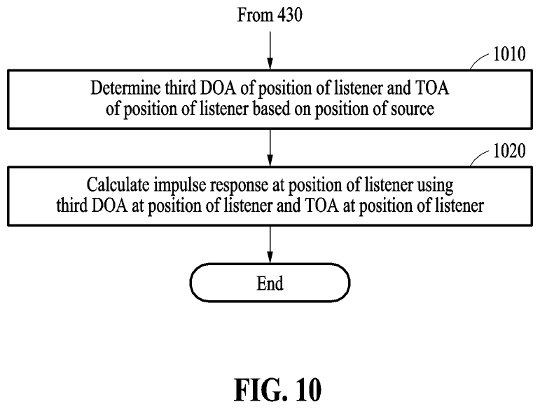

FIG. 10 is a diagram illustrating an operation of determining an impulse response at a position of a listener, according to various embodiments.

In operation 1010, the electronic device 400 may determine a third DOA of a position of a listener and a TOA of the position of the listener, based on a position of the source. For example, the electronic device 400 may determine the position of the source, using Equations 15 and 16 above. The electronic device 400 may calculate the azimuth and elevation for the source at the position of the listener, as shown in Equation 18 above.

The electronic device 400 may interpolate the time delay according to the distance between the source and the position of the listener. For example, the electronic device 400 may calculate the time delay of the specular source according to the distance between the direct source and the listener and the distance between the image source and the listener, as shown in Equation 20.

In operation 1020, the electronic device 400 may calculate the impulse response at the position of the listener, using the third DOA and the TOA at the position of the listener. The electronic device 400 may determine the B-format DRIR of the specular source, as shown in Equation 19. The electronic device 400 may calculate the B-format DRIR at the position of the listener, considering diffuse components, as shown in Equation 22.

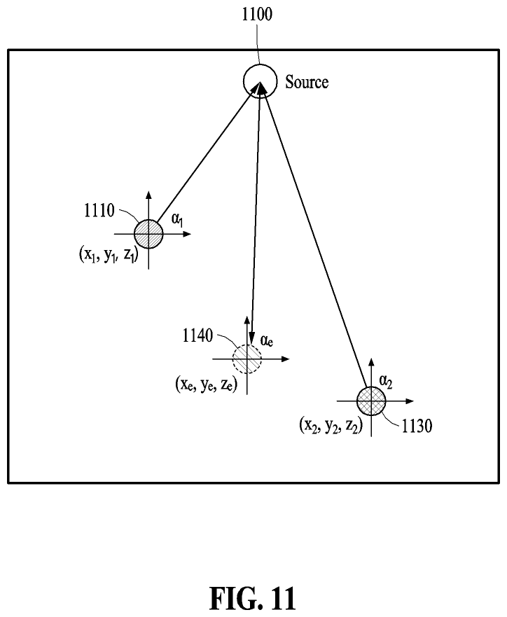

FIG. 11 is a diagram illustrating an operation of estimating a position of a source, according to various embodiments.

As shown in FIG. 11, the electronic device 400 may estimate a position of a source 1100, using a DOA at a first position 1110 and a DOA at a second position 1130.

When the first position 1110 is x₁, y₁, z₁ and the second position 1130 is x₂, y₂, z₂, the electronic device 400 may determine a 3D coordinate system position x₀, y₀, z₀ of the source 1100, as shown in Equations 15 and 16. The electronic device 400 may determine DOAs αₑ, βₑ for the source 1100 at a position 1140 of a listener, as shown in Equation 18.

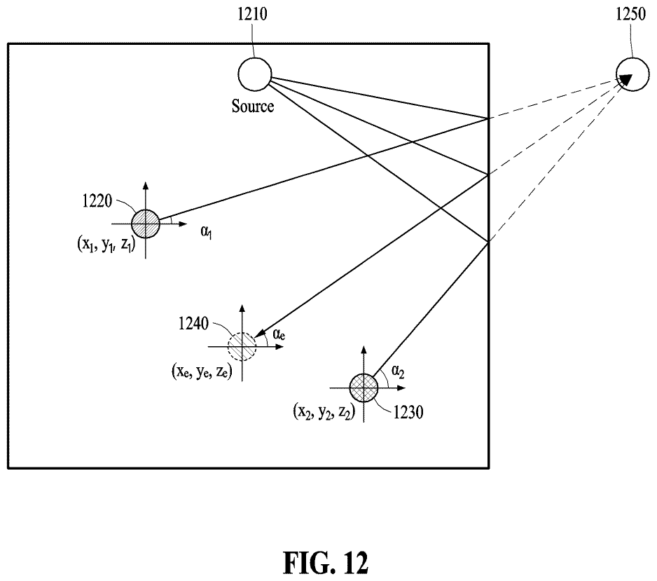

FIG. 12 is a diagram illustrating an operation of estimating a position of a source and a position of an image source, according to various embodiments.

As shown in FIG. 12, the electronic device 400 may estimate a position of an image source 1250, using a DOA of a first position 1220 and a DOA of a second position 1230. The DOA at the first position 1220 and the DOA at the second position 1230 may represent information on the direction in which the reflection sound transmitted from a source 1210 to the first position 1220 and the second position 1230 is incident.

When the first position 1110 is x₁, y₁, z₁ and the second position 1130 is x₂, y₂, z₂, the electronic device 400 may determine the 3D coordinate system position x₀, y₀, z₀ of the image source 1250, as shown in Equations 15 and 16. The electronic device 400 may determine DOAs αₑ, βₑ for the image source 1250 at a position αₑ, βₑ 1240 of a listener, as shown in Equation 18.

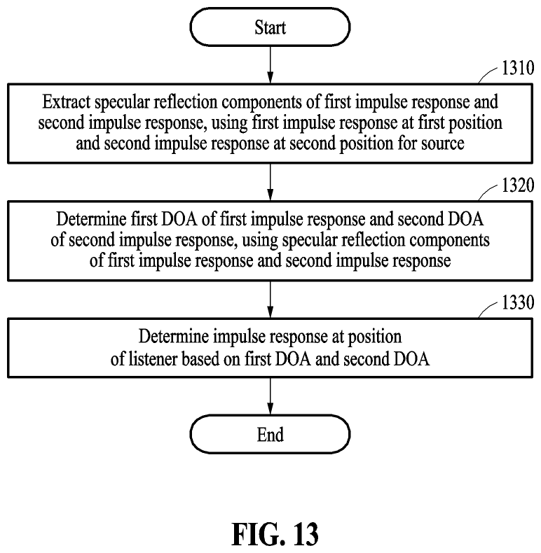

FIG. 13 is a flowchart of a method of determining an impulse response, according to various embodiments.

In operation 1310, the electronic device 400 may extract specular reflection components of the first impulse response and the second impulse response, using the impulse response at the first position and the impulse response at the second position for the source.

In operation 1320, the electronic device 400 may determine the first DOA of the first impulse response and the second DOA of the second impulse response, using the specular reflection components of the first impulse response and the second impulse response.

The description of operations 510 and 520 of FIG. 5 may apply to operations 1310 and 1320 of FIG. 13 substantially in the same manner.

In operation 1330, the electronic device 400 may determine the impulse response at the position of a listener, based on the first DOA and the second DOA. For example, when the position of the listener is on a straight line (or the center of the straight line) connecting the first position (e.g., a position of a first FOA microphone) to a second position (e.g., a position of a second FOA microphone), the electronic device 400 may determine the impulse response at the position of the listener based on the first DOA and the second DOA.

The electronic device 400 may represent DOAs

$${θ}_{j}^{i} ( n , {L}_{I} ) , {ϕ}_{j}^{i} ( n , {L}_{I} )$$

at the position L_{I} of the listener, using DOAs

$${θ}_{j}^{i} ( n , {L}_{1} ) , {ϕ}_{j}^{i} ( n , {L}_{1} )$$

at the first position and DOAs

$${θ}_{j}^{i} ( n , {L}_{1} ) , {ϕ}_{j}^{i} ( n , {L}_{1} )$$

at the second position, as shown in Equation 23 below.

$${θ}_{j}^{i} ( n , {L}_{I} ) = \frac{{d}_{I 2}}{{d}_{1 I} + {d}_{I 2}} * {θ}_{j}^{i} ( n , {L}_{1} ) + \frac{{d}_{1 I}}{{d}_{1 I} + {d}_{I 2}} * {θ}_{j}^{i} ( n , {L}_{2} ) , \qquad [ Equation 23 ]$$

$${ϕ}_{j}^{i} ( n , {L}_{I} ) = \frac{{d}_{I 2}}{{d}_{1 I} + {d}_{I 2}} * {ϕ}_{j}^{i} ( n , {L}_{1} ) + \frac{{d}_{1 I}}{{d}_{1 I} + {d}_{I 2}} * {ϕ}_{j}^{i} ( n , {L}_{2} ) ,$$

In Equation 23, d_{1I} and d_{I2} denote a distance from the position L_{I} of the listener to the first position L₁ and a distance from the position L_{I} of the listener to the second position L₂, respectively.

Since a DRIR at a position closer to the position of the listener contributes more to a DRIR at the position of the listener, a ratio set to

$${θ}_{j}^{i} ( n , {L}_{1} ) , {ϕ}_{j}^{i} ( n , {L}_{1} )$$

may be defined as a value obtained by dividing the distance from the position L_{I} of the listener to the second position L₂ by a total distance d_{1I}+d_{I2}.

The electronic device 400 may determine a TOA corresponding to the peak of the direct sound and specular reflection found in the impulse response at the first position L₁ and the second position L₂. For example, the electronic device 400 may determine a TOA at the position L₁ of the listener by interpolating the peak of the direct sound and specular source that are found at the first position L₁ and the second position L₂, using linear interpolation.

For example, the electronic device 400 may determine a TOA

$${n}_{j}^{i} ( n , {L}_{I} )$$

at the position of the listener, as shown in Equation 24 below.

$${n}_{j}^{i} ( n , {L}_{I} ) = \frac{{d}_{I 2}}{{d}_{1 I} + {d}_{I 2}} * {n}_{j}^{i} ( n , {L}_{1} ) + \frac{{d}_{1 I}}{{d}_{1 I} + {d}_{I 2}} * {n}_{j}^{i} ( n , {L}_{2} ) \qquad [ Equation 24 ]$$

In equation 24,

$${n}_{j}^{i} ( n , {L}_{1} )$$

denotes a peak found at the direct source and specular reflection extracted from the first position L_{I} and

$${n}_{j}^{i} ( n , {L}_{2} )$$

denotes a TOA of a peak found in the direct source and specular reflection extracted from the second position.

The electronic device 400 may determine the impulse response at the position L_{I} of the listener, using the DOA and TOA at the position L_{I} of the listener, as shown in Equations 19 to 22 above.

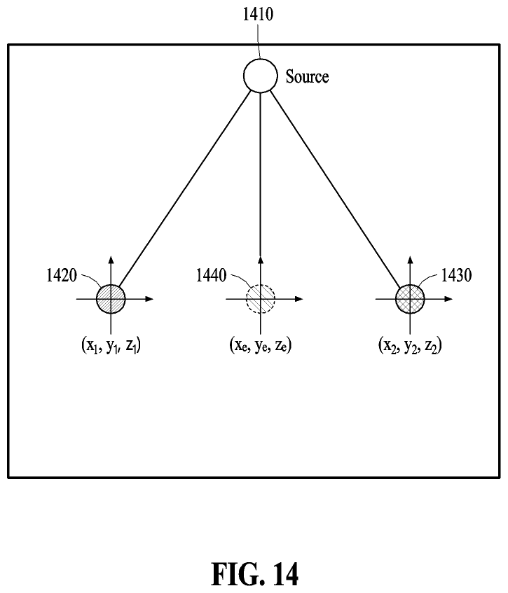

FIG. 14 is a diagram illustrating an operation of determining a DOA and a TOA of a position of a listener, according to various embodiments.

As shown in FIG. 14, when a position xₑ, yₑ, zₑ 1440 of a listener is on a straight line of a first position x₁, y₁, z₁ 1420 and a second position x₂, y₂, z₂ 1430, the electronic device 400 may determine a DOA and a TOA of the position 1440 of the listener for a source 1410.

For example, the electronic device 400 may determine the DOA at the position 1440 of the listener as shown in Equation 23, and the TOA at the position 1440 of the listener as shown in Equation 24.

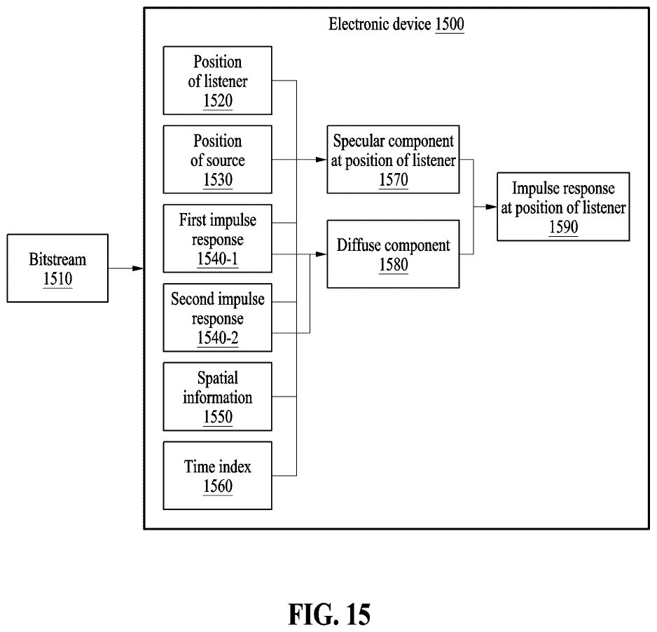

FIG. 15 is a schematic block diagram of an electronic device 1500 according to various embodiments.

The electronic device 1500 may receive a bitstream 1510 including a position of a listener 1520, a position of a source 1530, a first impulse response 1540-1 at a first position, and a second impulse response 1540-2 at a second position.

The electronic device 1500 may determine an impulse response at a position of a listener 1590 by interpolating the first impulse response 1540-1 and the second impulse response 1540-2.

For example, the electronic device 1500 may determine a DOA of the position of the listener 1520, using the position of the source 1530 and the position of the listener 1520. The electronic device may determine a specular component of a position of a listener 1570 (e.g., the B-format DRIR of the specular source at the position of the listener) using the DOA of the position of the listener 1520, as shown in Equation 19. The electronic device 1500 may determine the impulse response at the position of the listener 1590 using a diffuse component 1580 of the first impulse response 1540-1 or the second impulse response 1540-2, as shown in Equation 22.

In another example, the bitstream 1510 may include spatial information 1550 on the DOA at the position of the listener 1520 and a time index 1560 about the TOA at the position of the listener 1520. The electronic device 1500 may determine the specular component at the position of the listener 1570 (e.g., the B-format DRIR of the specular source at the position of the listener) using the spatial information 1550 and/or the time index 1560.

The embodiments described herein may be implemented using a hardware component, a software component and/or a combination thereof. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software may also be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described embodiments, or vice versa.

As described above, although the embodiments have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

1. A method of determining an impulse response, the method comprising:
using a first impulse response at a first position and a second impulse response at a second position for a source, extracting a specular reflection component of the first impulse response and the second impulse response;
determining a first direction of arrival (DOA) of the first impulse response and a second DOA of the second impulse response using the specular reflection component of the first impulse response and the second impulse response;
estimating a position of the source based on the first DOA and the second DOA; and
determining an impulse response at a position of a listener based on the position of the source.

2. The method of claim 1, wherein the determining of the impulse response at the position of the listener comprises:
determining a third DOA at the position of the listener and a time of arrival (TOA) at the position of the listener based on the position of the source; and
calculating the impulse response at the position of the listener using the third DOA at the position of the listener and the TOA at the position of the listener.

3. The method of claim 2, wherein the calculating of the impulse response at the position of the listener comprises correcting at least one of the first impulse response and the second impulse response based on the third DOA and the TOA.

4. The method of claim 2, further comprising:
calculating a diffuse component of at least one of the first impulse response and the second impulse response,
wherein the calculating of the impulse response at the position of the listener comprises calculating the impulse response at the position of the listener based on the diffuse component and a set weight.

5. The method of claim 1, wherein the estimating of the position of the source comprises estimating the position of the source and a position of an image source corresponding to the source, using triangulation.

6. The method of claim 1, wherein the extracting of the specular reflection component comprises extracting the specular reflection component of the first impulse response and the second impulse response to be less than or equal to a set number, respectively.

7. The method of claim 1, wherein the extracting of the specular reflection component comprises:
detecting a peak based on power of a W channel of the first impulse response and the second impulse response; and
extracting the specular reflection component of the first impulse response and the second impulse response based on the peak.

8. The method of claim 7, wherein the detecting of the peak comprises:
applying a first filter and a second filter to the power of the W channel; and
detecting the peak based on a ratio of the power of the W channel to which the first filter is applied and the power of the W channel to which the second filter is applied.

9. An electronic device comprising:
a processor,
wherein the processor is configured to:
using a first impulse response at a first position and a second impulse response at a second position for a source, extract a specular reflection component of the first impulse response and the second impulse response;
determine a first direction of arrival (DOA) of the first impulse response and a second DOA of the second impulse response using the specular reflection component of the first impulse response and the second impulse response;
estimate a position of the source based on the first DOA and the second DOA; and
determine an impulse response at a position of a listener based on the position of the source.

10. The electronic device of claim 9, wherein the processor is configured to:
determine a third DOA at the position of the listener and a time of arrival (TOA) at the position of the listener based on the position of the source; and
calculate the impulse response at the position of the listener using the third DOA at the position of the listener and the TOA at the position of the listener.

11. The electronic device of claim 10, wherein the processor is configured to correct at least one of the first impulse response and the second impulse response based on the third DOA and the TOA.

12. The electronic device of claim 10, wherein the processor is configured to:
calculate a diffuse component of at least one of the first impulse response and the second impulse response; and
calculate the impulse response at the position of the listener based on the diffuse component and a set weight.

13. The electronic device of claim 9, wherein the processor is configured to estimate the position of the source and a position of an image source corresponding to the source, using triangulation.

14. The electronic device of claim 9, wherein the processor is configured to extract the specular reflection component of the first impulse response and the second impulse response to be less than or equal to a set number, respectively.

15. The electronic device of claim 9, wherein the processor is configured to:
detect a peak based on power of a W channel of the first impulse response and the second impulse response; and
extract the specular reflection component of the first impulse response and the second impulse response based on the peak.

16. The electronic device of claim 15, wherein the processor is configured to:
apply a first filter and a second filter to the power of the W channel; and
detect the peak based on a ratio of the power of the W channel to which the first filter is applied and the power of the W channel to which the second filter is applied.

17. An electronic device comprising:
a processor,
wherein the processor is configured to:
receive a bitstream comprising a position of a listener, a position of a source, a first impulse response at a first position, and a second impulse response at a second position; and
determine a third impulse response at the position of the listener by interpolating the first impulse response and the second impulse response based on the position of the source and the position of the listener.

18. The electronic device of claim 17, wherein
a specular reflection component of the first impulse response and the second impulse response is extracted, and
a first direction of arrival (DOA) of the first impulse response and a second DOA of the second impulse response are determined using the specular reflection component of the first impulse response and the second impulse response,
wherein the position of the source is estimated based on the first DOA and the second DOA.
